(19) United States
(12) Patent Application Publication
(10) Pub. No.: US 2002/0198932 A1
(43) Pub. Date: Dec. 26, 2002

(54) System of server-client distributed computing using passive clients

(76) Inventor: Christopher Shaun Wagner, Charleston, SC (US)

Correspondence Address: Christopher S. Wagner, 2222 Ashley River Road, Apt 3E, Charleston, SC, 29414, US

(21) Appl. No.: 09/875,665

(22) Filed: Jun. 7, 2001

(51) Int. Cl. G06F 15/16

(52) U.S. Cl. 709/203; 707/513

(57) ABSTRACT

Distributed computing may be achieved through a network protocol, such as Hypertext Transfer Protocol (HTTP), commonly referred to as “the web.” The server for the distributed computer is a server-side program/script that creates client-side programs/scripts that are attached to the data requested by a client. The server also listens for responses, such as HTTP requests from the clients. The client-side programs/scripts perform parts of the overall calculation and respond to the server only if necessary. With enough traffic to a server that implements this system, the computing power of a supercomputer may easily be matched.

### DESCRIPTION

### Background

Christopher S. Wagner invented this system of distributed computing after reading about a form of distributed computing on The Code Book Cipher Challenge Solution Page. The winners of the Cipher Challenge implemented a system of distributed computing by encoding the client-side program in a screen saver. The limit of this system is the need for users to voluntarily install the client-side program on their computer. The usefulness of this system of distributed computing is the ability to create a vast collection of clients without action on the user's part.

The first idea was a virus-like system in which client-side programs could be delivered from one computer to another in any way that a virus is delivered from one computer to another. That would be more harmful that useful. An alternative method is to deliver temporary client-side programs to computers in a protected processing environment, such as the script-processing environment in most web browsers. A user of the web does not have to perform any action to accept a script in a web page, which allows wide distribution and passive execution of client-side programs.

### Development

Development began the day after the invention was fully conceived, May 24, 2001. A server-side script, written in PHP on an Apace web server, was added to the chris.kainaw.com website to factor numbers. The server-side script, referred to as the Wagner Virtual Supercomputer, broke the process of factoring the given number into many starting points, Each web page requested from the website was given a client-side script to factor the given number with a random starting point. When a client found a solution to the factoring problem, it would reload the current web page with the solution in the query string of the URL. The server monitored all HTTP requests for responses in the query string and sent the result through email to all people monitoring the progress of the overall program. The code for this implementation is the Example section.

### Benefits

There are many benefits of distributed computing, as seen on The Internet-Based Distributed Computing website. These include the search for extra terrestrial radio signals, the study of genomic decay, and modeling influenza vaccines. Each of these computational problems requires many hours, possibly many years, of computer processing time. By having many computers working on the same overall problem, but actually working on different parts of the problem, the time required to find a solution is reduced.

Time reduction in distributed computing is directly related to the number of clients processing parts of the overall problem. This system has the ability to create a vast collection of clients because it does not require the users to install a client-side program in order to participate.

### Definitions

Certain terms used herein have vague meanings in common use. In this document, they specifically mean the following:

Server-Side Program/Script: A program or script that runs on a server, such as a web server. The output of a server-side program/script may be added to any web page.

Client-Side Program/Script: A program or script that runs on a computer that has accessed a server. In the case of a web server, the client-side script is included in a web page and may or may not be noticeable to the viewer of the web page. Query String of a URL: A query string is a standard part of a URL (Universal Resource Locator) that follows a question mark (?) inserted into the URL. The query string contains variable names and values that may be of use to a server-side script.

### SUMMARY OF THE INVENTION

Distributed computing is a very general term referring to any system of using more than one computer to process a single task. In this case, distributed computing refers specifically to the server-client model of distributed computing in which a server does not perform any of the calculations required to solve the problem. It only delivers programs or code to and monitors the progress of the clients. The clients perform all of the required calculations.

Any network-based application that allows the use of background programs or scripting may be used as a client. Web pages are a powerful medium for delivery of client-side code because most web browsers keep the client-side scripts from causing any harm, malicious or accidental, to the user's computer. Also, there are many forms of server-side programs and scripts, such as CGI scripts, PHP, and ASP, which can easily customize and deliver client-side code to a computer that requests a web page.

Any calculation that may be divided into smaller parts or any calculation that has a known set of possible answers may be solved with distributed computing. This system has an advantage over other distributed computing systems by not requiring the clients to perform any action to accept and install the client-side program. The number of clients is simply the number of visitors to any website that implements this system of distributed computing. Given a large number of visitors, the processing power increases dramatically.

It is also possible to increase the power of the system with a tiered server. One server divides the problem among multiple middle servers. The middle servers divide the problem again and either delivers those divisions to other servers or directly to clients. The number of end clients is a measure of the power of the system. The goal is to implement a system that gathers the most clients possible.

### EXAMPLE

In this example, PHP is used as a server-side script on a web server (Apache) to produce JavaScrpt clients. The clients respond to the PHP server-side script with a query string in an HTTP request.

<?
$wbf_number=7571; // Number to factor
function wbf_factor()
{

global $wbf_number, $REQUEST_URI;
$root=sqrt ($wbf_number);
$parts=ceil ($root/100);
$index=mktime () %$parts;
$start=100*$index+1;
if ($start==1) $start=3;
if (strpos ($REQUEST_URI, “?”)==0)

$reload=$REQUEST_URI. “?wbf_factor=”;

else $reload=$REQUEST_URI.“&wbf_factor=”;
print”

<SCRIPT LANGUAGE=‘javascript’><!--
var i=$start;
while (true)
{

if ($wbf_number%i==0) document.location=‘$reload’+i;
1=i+2;
if (i>$root) i=3;
if (i==$start) break;

}
//--></SCRIPT>

”;

}
if (($wbf_factor>0) && ($wbf_number%$wbf_factor==0))
{

$fw=fopen (“wbf_solution.txt”, “w”);
fputs ($fw, “The factors of $wbf_number are $wbf_factor and

”. ($wbf_number/$wbf_factor));

mail (“chris@kainaw.com”, “WBF-Solution”, “We solved it!”);
fclose ($fw);

}
if (!file_exists (“wbf_solution.txt”)) wbf_factory ();
?>

### REFERENCES

The Cipher Challenge Homepage, http://www.4thestate.co.uk/CipherChallenge/, referenced May 18, 2001.

The Code Book Cipher Challenge Solution Page, http://www.codebook.org/, referenced May 20, 2001.

Internet-Based Distributed Computing Projects, http:/www.nyx.net/˜kpearson/distrib-projects.html, referenced May 29, 2001.

I claim:

1. A system of distributed computing, which comprises:
a. The use of a network protocol to transmit data between a server and clients on networks where other data is currently being distributed from a server to clients.
b. A server-side program/script to create client-side programs/scripts that are attached to the data requested by a client.
c. The client receives the client-side program/script without any action other than the normal request for data.
d. Client-side programs/scripts perform the work required.
e. The client-side program/script may respond to the server through an adapted data request.

2. A system as described in claim 1 may be implemented through many combinations of common protocols and programs, such as:
a. Hypertext Transfer Protocol (HTTP) is used to transfer web pages that may contain programs or scripts.
b. PHP and ASP both offer server-side scripting ability to create client-side scripts in web pages and monitor HTTP requests for responses from client-side scripts.
c. JavaScript, included in a web page, will perform most tasks required for most computing problems. JavaScript can respond to a server with an HTTP request.

3. A system as described in claim 1 may be implemented as described in claim 2 so that the distributed computing system does not require any action from the users of HTTP server, commonly referred to as web surfers.

4. A system as described in claim 1 may be tiered. A master server may distribute computing to other servers, which in turn distribute the computing to more servers or clients.
